(19) United States
(12) Patent Application Publication
(10) Pub. No.: US 2017/0265100 A1
(43) Pub. Date: Sep. 14, 2017

(54) METHOD FOR CONFIGURING APN-AMBR IN WIRELESS COMMUNICATION SYSTEM SUPPORTING CSIPTO AND DEVICE THEREFOR

(71) Applicant: LG ELECTRONICS INC., Seoul (KR)

(72) Inventors: Jinsook RYU, Seoul (KR); Laeyoung KIM, Seoul (KR); Hyunsook KIM, Seoul (KR); Jaehyun KIM, Seoul (KR); Taehun KIM, Seoul (KR)

(73) Assignee: LG ELECTRONICS INC., Seoul (KR)

(21) Appl. No.: 15/309,761

(22) PCT Filed: May 11, 2015
(86) PCT No.: PCT/KR2015/004680

§ 371 Date: Nov. 8, 2016

Related U.S. Application Data
(60) Provisional application No. 61/991,599, filed on May 11, 2014.

(51) Int. Cl. H04W 28/02; H04W 76/02

(52) U.S. Cl. CPC H04W 28/02; H04W 76/02; H04W 88/16

(57) ABSTRACT

The present invention relates to a method and a device by which a UE configures a per access point name aggregate maximum bit rate (APN-AMBR) in a wireless communication system supporting coordinated selected IP traffic offload (CSIPTO). Particularly, the method comprises the steps of: configuring a plurality of PDN connections associated with different packet data network-gateways (P-GWs) for the same APN; respectively calculating APN-AMBRs of the plurality of PDN connections on the basis of the number of non-guaranteed bit rate (non-GBR) bearers for each of the plurality of PDN connections; and applying the APN-AMBRs to the respective, corresponding PDN connections.

### CROSS-REFERENCE TO RELATED APPLICATIONS

This application is the National Stage filing under 35 U.S.C. 371 of International Application No. PCT/KR2015/004680, filed on May 11, 2015, which claims the benefit of U.S. Provisional Application No. 61/991,599, filed on May 11, 2014, the contents of which are all hereby incorporated by reference herein in their entirety.

### TECHNICAL FIELD

The present invention relates to a wireless communication system, and more particularly, to a method of configuring APN-AMBR (Per APN-Aggregate Maximum Bit Rate) in a wireless communication system supportive of CSIPTO (Co-Ordinated Selected IP Traffic Offload) and apparatus therefor.

### BACKGROUND ART

A 3rd generation partnership project long term evolution (3GPP LTE) (hereinafter, referred to as “LTE”) communication system which is an example of a wireless communication system to which the present invention can be applied will be described in brief.

FIG. 1 is a diagram illustrating a network structure of an Evolved Universal Mobile Telecommunications System (E-UMTS) which is an example of a wireless communication system. The E-UMTS is an evolved version of the conventional UMTS, and its basic standardization is in progress under the 3rd Generation Partnership Project (3GPP). The E-UMTS may be referred to as a Long Term Evolution (LTE) system. Details of the technical specifications of the UMTS and E-UMTS may be understood with reference to Release 7 and Release 8 of “3rd Generation Partnership Project; Technical Specification Group Radio Access Network”.

Referring to FIG. 1, the E-UMTS includes a User Equipment (UE), base stations (eNode B; eNB), and an Access Gateway (AG) which is located at an end of a network (E-UTRAN) and connected to an external network. The base stations may simultaneously transmit multiple data streams for a broadcast service, a multicast service and/or a unicast service.

One or more cells exist for one base station. One cell is set to one of bandwidths of 1.44, 3, 5, 10, 15 and 20 MHz to provide a downlink or uplink transport service to several user equipments. Different cells may be set to provide different bandwidths. Also, one base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic may be used between the base stations. A Core Network (CN) may include the AG and a network node or the like for user registration of the user equipment. The AG manages mobility of the user equipment on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure and open type interface, proper power consumption of the user equipment, etc. are required.

### DISCLOSURE OF THE INVENTION

### Technical Task

Based on the above discussion, the technical task of the present invention is to efficiently configure APN-AMBR (Per APN-Aggregate Maximum Bit Rate) in a wireless communication system supportive of CSIPTO (Co-Ordinated Selected IP Traffic Offload).

Technical tasks obtainable from the present invention are non-limited by the above-mentioned technical task. And, other unmentioned technical tasks can be clearly understood from the following description by those having ordinary skill in the technical field to which the present invention pertains.

### Technical Solutions

In one technical aspect of the present invention, provided herein is an APN-AMBR configuring method in configuring an APN-AMBR (per APN aggregate maximum bit rate) of a user equipment in a wireless communication system supportive of CSIPTO (co-ordinated selected IP traffic offload), including establishing multiple PDN connections associated with different P-GW (packet data network gateways) for a same APN (access point name), calculating APN-AMBRs for the multiple PDN connections based on the number of non-GBR (non-guaranteed bit rate) bearers for the respective multiple PDN connections, respectively, and applying the APN-AMBRs to the corresponding PDN connections, respectively.

Preferably, the multiple PDN connections may include a first PDN connection associated with a first P-GW according to movement of the user equipment and a second PDN connection associated with a second P-GW according to a location before the movement of the user equipment. More preferably, the calculating the APN-AMBRs may be performed in case of receiving an indicator indicating the first P-GW different from the second P-GW according to the first PDN connection configuration. More preferably, the number of the non-GBR bearers of the second PDN connection may include the number of the non-GBR bearers except a default bearer. More preferably, the second PDN connection may be maintained until a service continuity & IP preservation requested long-lived service flow expires.

Preferably, the APN-AMBR configuring method may further include transmitting the APN-AMBRs for the respective multiple PDN connections to a network entity. More preferably, the APN-AMBR configuring method may include receiving a downlink signal according to the APN-AMBR of the network entity reconfigured based on the APN-AMBRs for the respective multiple PDN connections from the network entity.

Preferably, the APN-AMBR configuring method may include receiving a downlink signal according to the APN-AMBRs for the respective multiple PDN connections calculated based on PDN connection information. More preferably, the PDN connection information may include at least one of an information indicating whether the multiple PDN connections belong to the same APN, information indicating whether the multiple PDN connections are connected to a different P-GW, and bearer QoS (quality of service) information for each of the multiple PDN connections.

In another technical aspect of the present invention, provided herein is a user equipment in configuring an APN-AMBR (per APN aggregate maximum bit rate) in a wireless communication system supportive of CSIPTO (co-ordinated selected IP traffic offload), including a radio frequency unit and a processor configured to establish multiple PDN connections associated with different P-GW (packet data network gateways) for a same APN (access point name), calculate APN-AMBRs for the multiple PDN connections based on the number of non-GBR (non-guaranteed bit rate) bearers for the respective multiple PDN connections, respectively, and apply the APN-AMBRs to the corresponding PDN connections, respectively.

### Advantageous Effects

According to the present invention, APN-AMBR configuration can be performed more efficiently in a wireless communication system supportive of CSIPTO.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a structure of an E-UMTS network as one example of a wireless communication system.

FIG. 2 shows a schematic structure of an EPS (evolved packet system) including an EPC (evolved packet core).

FIG. 3 shows a structure of a bearer (or an EPS bearer).

FIG. 4 is a reference diagram to describe a CSIPTO scenario.

FIG. 5 is a reference diagram to describe a case of APN-AMBR handling on CSIPTO.

FIG. 6 is a diagram for configuration of one example of a user equipment device and a network node device according to a preferred embodiment of the present invention.

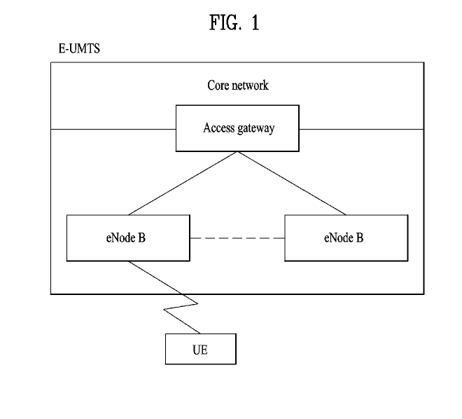

### BEST MODE FOR INVENTION

The embodiments of the present invention described above are combinations of elements and features of the present invention in a predetermined form. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment.

Specific terms used in the following description are provided to aid in understanding the present invention and these specific terms may be replaced with other terms within the scope and spirit of the present invention.

In some instances, well-known structures and devices are omitted in order to avoid obscuring the concepts of the present invention and the important functions of the structures and devices are shown in block diagram form. The same reference numbers will be used throughout the drawings to refer to the same or like parts.

Embodiments of the present invention can be supported by standard documents disclosed for at least one of wireless access systems such as institute of electrical and electronics engineers (IEEE) 802, 3rd generation partnership project (3GPP), 3GPP long term evolution (3GPP LTE), LTE-advanced (LTE-A), and 3GPP2 systems. For steps or parts, description of which is omitted to clarify the technical features of the present invention, reference may be made to these documents. Further, all terms as set forth herein can be explained by the standard documents.

The following technology can be used in various wireless communication systems. For clarity, a description will be given focusing on the 3GPP LTE and 3GPP LTE-A systems. However, the technical spirit of the present invention is not limited thereto.

Terminologies used in this disclosure are defined as follows.
UMTS (Universal Mobile Telecommunications System): 3rd generation mobile communication technology based on Global System for Mobile Communication (GSM), developed by 3GPP.
EPS (Evolved Packet System): A network system comprised of an Evolved Packet Core (EPC), which is an Internet Protocol (IP) based packet switched core network, and an access network such as LTE or UMTS Terrestrial Radio Access Network (UTRAN). EPS evolved from UMTS.
NodeB: A Base Station (BS) of GERAN/UTRAN. NodeB is installed outdoors and coverage thereof is a macro cell size.
eNodeB: A BS of LTE. eNodeB is installed outdoors and coverage thereof is a macro cell size.
UE (User Equipment): UE may be referred to as terminal, Mobile Equipment (ME), or Mobile Station (MS). UE may be a portable device, such as a notebook, a cellular phone, a Personal Digital Assistant (PDA), a smartphone, or a multimedia device or may be a non-portable device such as a PC (Personal Computer) or a vehicle mounted device. UE can perform communication using a 3GPP spectrum such as LTE and/or a non-3GPP spectrum such as a spectrum for Wi-Fi or public safety.
RAN (Radio Access Network): A unit including NodeB, eNodeB and RNC (Radio Network Controller) controlling them in a 3GPP network. This exists between a UE and a core network and provides a connection to the core network.
HLR/HSS (Home Location Register/Home Subscriber Server): Database having subscriber information in a 3GPP network. HSS can perform functions of configuration storage, identity management, user state storage and the like.
RANAP (RAN Application Part): Interface between an RAN and a node (MME (Mobility Management Entity)/SGSN(Serving GPRS(General Packet Radio Service) Supporting Node)/MSC(Mobiles Switching Center)) responsible for a control of a core network.
PLMN (Public Land Mobile Network): Network configured to provide individuals with a mobile communication service. This can be configured by being sorted per operator.
NAS (Non-Access Stratum): Functional layer for signaling between a UE and a core network in a UMTS protocol stack and exchanging messages therebetween. This mainly supports mobility of a UE and a session management procedure for establishing and maintaining an IP connection between the UE and PDN GW (packet data network gateway).
HNB (Home NodeB): CPE (Customer Premises Equipment) providing UTRAN (UMTS Terrestrial Radio Access Network) coverage. For details, the standard document TS 25.467 can be referred to.
HeNodeB (Home eNodeB): CPE (Customer Premises Equipment) providing E-UTRAN (Evolved-UTRAN) coverage. For details, the standard document TS 36.300 can be referred to.
CSG (Closed Subscriber Group): Subscriber group allowed to access one or more CSG cells in PLMN (Public Land Mobile Network) as a member of CSG of H(e)NB.
LIPA (Local IP Access): Access of an IP capable UE to another IP capable entity in the same residential/enterprise IP network via H(e)NB. LIPA traffic does not pass through a mobile communication operator network. In 3GPP Release-10 system, an access to a resource on a local network (i.e., a network located at customer's home or inside a company) via H(e)NB.
SIPTO (Selected IP Traffic Offload): 3GPP Rlease-10 system supports an operator to pass user's traffic by selecting PGW (Packet data network GateWay) located physically close to a UE in an EPC network.
PDN (Packet Data Network) connection: Logical connection between a UE represented as a single IP address (single IPv4 address and/or single IPv6 prefix) and a PDN represented as an APN (Access Point Name).

### EPC(Evolved Packet Core)

FIG. 2 is a view schematically illustrating the architecture of an Evolved Packet System (EPS) including an Evolved Packet Core (EPC).

The EPC is a core element of System Architecture Evolution (SAE) for improving the performance of 3GPP technology. SAE corresponds to a study item for deciding a network structure supporting mobility among various types of network. SAE aims to provide, for example, an optimized packet-based system which supports various radio access technologies based on IP and provides improved data transfer capabilities.

Specifically, the EPC is a core network of an IP mobile communication system for a 3GPP LTE system and may support packet-based real-time and non-real-time services. In a legacy mobile communication system (e.g., 2nd or 3rd generation mobile communication system), a core network function is implemented through two separated sub-domains, e.g., circuit-switched (CS) sub-domain for sound and packet-switched (PS) sub-domain for data. However, in a 3GPP LTE system which is evolved from the 3rd generation communication system, the CS and PS sub-domains are unified into a single IP domain. For example, in the 3GPP LTE system, IP-capable UEs can be connected via an IP-based base station (e.g., eNodeB (evolved Node B)), an EPC, an application domain (e.g., IMS (IP Multimedia Subsystem)). That is, the EPC is a structure inevitably required to implement end-to-end IP service.

The EPC may include various components and FIG. 2 illustrates a few of the components, e.g., Serving GateWay (SGW), Packet Data Network GateWay (PDN GW), Mobility Management Entity (MME), Serving GPRS (General Packet Radio Service) Supporting Node (SGSN), and enhanced Packet Data Gateway (ePDG).

The SGW operates as a boundary point between a Radio Access Network (RAN) and a core network and is an element which performs a function for maintaining a data path between an eNodeB and a PDG GW. In addition, if a UE moves across an area served by an eNodeB, the SGW serves as a local mobility anchor point. That is, packets may be routed via the SGW for mobility in an Evolved-UMTS (Universal Mobile Telecommunications System) Terrestrial Radio Access Network (E-UTRAN) defined after 3GPP Release-8. Further, the SGW may serve as an anchor point for mobility management with another 3GPP network such as RAN defined before 3GPP Release-8, e.g., UTRAN or GSM (Global System for Mobile communication)/EDGE (Enhanced Data rates for GSM Evolution) Radio Access Network (GERAN).

The PDN GW (or P-GW) corresponds to a termination point of a data interface directed to a packet data network. The PDN GW may support policy enforcement features, packet filtering and charging support. In addition, the PDN GW may serve as an anchor point for mobility management with a 3GPP network and a non-3GPP network (e.g., untrusted network such as Interworking Wireless Local Area Network (I-WLAN) and trusted network such as Code Division Multiple Access (CDMA) or WiMax).

Although the SGW and the PDN GW are configured as separate gateways in the network architecture of FIG. 2, the two gateways may be implemented according to a single gateway configuration option.

The MME performs signaling and control functions to support access of a UE for network connection, network resource allocation, tracking, paging, roaming and handover. The MME controls control plane functions related to subscriber and session management. The MME manages a large number of eNodeBs and performs signaling for selection of a typical gateway for handover to another 2G/3G network. In addition, the MME performs security procedures, terminal-to-network session handling, idle terminal location management, etc.

The SGSN handles all packet data such as mobility management and authentication of a user for another 3GPP network (e.g., GPRS network).

The ePDG serves as a security node for an untrusted non-3GPP network (e.g., I-WLAN, Wi-Fi hotspot, etc.).

As described above in relation to FIG. 2, an IP-capable UE may access an IP service network (e.g., IMS) provided by an operator, via various elements in the EPC based on non-3GPP access as well as 3GPP access.

FIG. 2 also illustrates various reference points (e.g., S1-U, S1-MME, etc.). In the 3GPP system, a conceptual link connecting two functions of different functional entities of E-UTRAN and EPC is defined as a reference point. Table 1 lists the reference points illustrated in FIG. 2. In addition to the examples of Table 1, various reference points may be present according to network architectures.

TABLE 1

| Reference | |
|---|---|
| Point | Description |
| S1-MME | Reference point for the control plane protocol between E-UTRAN and |
| | MME |
| S1-U | Reference point between E-UTRAN and Serving GW for the per bearer user |
| | plane tunneling and inter eNodeB path switching during handover |
| S3 | It enables user and bearer information exchange for inter 3GPP access |
| | network mobility in idle and/or active state. This reference point can be used |
| | intra-PLMN or inter-PLMN (e.g. in the case of Inter-PLMN HO). |
| S4 | It provides related control and mobility support between GPRS Core and the |
| | 3GPP Anchor function of Serving GW. In addition, if Direct Tunnel is not |
| | established, it provides the user plane tunneling. |
| S5 | It provides user plane tunneling and tunnel management between Serving |
| | GW and PDN GW. It is used for Serving GW relocation due to UE mobility |
| | and if the Serving GW needs to connect to a non-collocated PDN GW for |
| | the required PDN connectivity. |
| S11 | Reference point between MME and SGW |
| SGi | It is the reference point between the PDN GW and the packet data network. |
| | Packet data network may be an operator external public or private packet |
| | data network or an intra operator packet data network, e.g. for provision of |
| | IMS services. This reference point corresponds to Gi for 3GPP accesses. |

Among the reference points illustrated in FIG. 2, S2a and S2b correspond to non-3GPP interfaces. S2a is a reference point for providing a user plane with related control and mobility support between the trusted non-3GPP access and the PDNGW. S2b is a reference point for providing a user plane with related control and mobility support between the ePDG and the PDNGW.

### EPS Bearer Concept

In 3GPP RPS (evolved packet system), an EPS bearer is a user plane path and can be called a transceiving passage of up/down IP flow.

Once a UE is attached to an EPS system, an IP address is assigned and a single default bearer is created per PDN connection. If QoS (quality of service) is not met with the default bearer, a dedicated bearer may be created to enable a service. If a default bearer is created once, a corresponding PDN is maintained unless disconnected. Moreover, at least one default bearer should be maintained until a US is detached from an EPS.

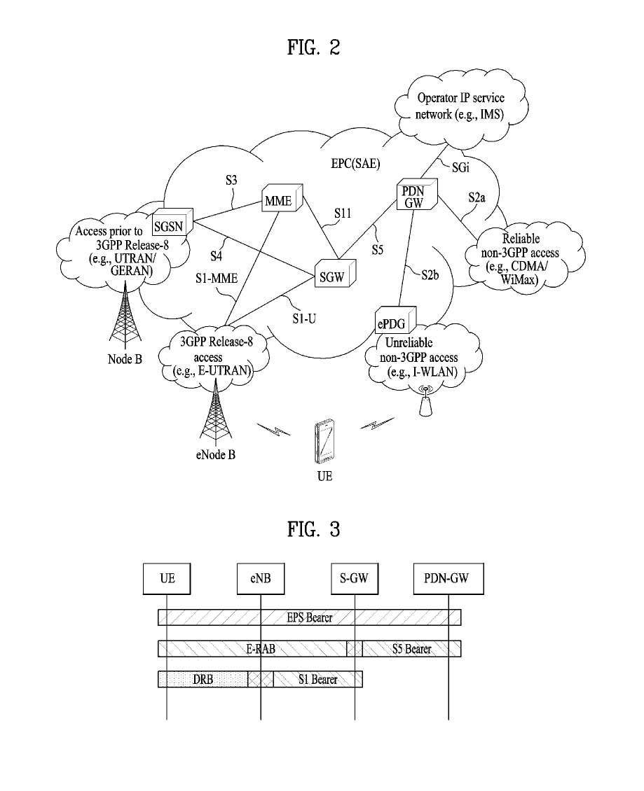

FIG. 3 shows a structure of a bearer (or an EPS bearer).

A bearer (or, EPS bearer) is named a different name per section. Referring to FIG. 3, an EPS bearer is divided into an E-RAB and an S5 bearer according to the sections. In particular, an EPS bearer section existing in idle state of a UE is the S5 bearer. If a connected mode (ECM-CONNECTED) is entered, E-RAT is set up so that a connection between UE, eNB and P-GW is established.

In addition, in FIG. 3, the E-RAB carries packets of the EPS bearer between the UE and the EPC. If the E-RAB exists, one-to-one mapping is established between the E-RAB and the EPS bearer. A data radio bearer (DRB) carries packets of the EPS bearer between the UE and the eNB. If the data radio bearer (DRB) exists, one-to-one mapping is established between the data radio bearer and the EPS bearer/E-RAB.

Moreover, the S1 bearer carries packets of the E-RAB between the eNodeB and the S-GW (serving GW). The S5/S8 bearer carries packets of the EPS bearer between the S-GW (serving GW) and the P-GW (PDN GW).

Moreover, the above-described bearer structures can refer to 13.1 ‘Bearer service architecture’ of the LTE/LTE-A standard document 36.300.

### CSIPTO (Co-Ordinated SIPTO)

With respect to the existing LTE standard, in 3GPP, SIPTO (Selected IP Traffic Offload) is specified in order to route a traffic (e.g., internet traffic) selected by Release 10 to a network node near a location of UE (e.g., UE's point of attachment to the access network).

Such an SIPTO operation defined in the LTE standard document is described as follows.

As a result of UE mobility (e.g., detected by the MME at TAU or movement from GERAN), a target MME can determine that a PDN connection is redirected to a GW (GateWay) further appropriate for a current location of UE. In this case, the GW further appropriate for the current location of the UE means a geographically/topologically closer GW from a location of the UE (e.g., UE's point of attachment).

Once the MME determines GW relocation, the MME performs a PDN disconnection procedure for directing ‘reactivation requested’ to the UE for a PDN connection to redirect. If it is determined to relocate all PDN connections for the UE, the MME performs a detach procedure for directing “explicit detach with reattach required” to the UE.

If the GW relocation operation is performed when the UE has active application(s), i.e., when a traffic using a GW relocation performed PDN connection exists, it may cause a service disruption due to a change of an IP address used by the UE.

Accordingly, in order to solve the above service disruption problem, in 3GPP Release 11, when the MME deactivates a PDN connection to perform the P-GW relocation (GW relocation) due to SIPTO through MME configuration, it is set to be performed 1) while the UE is in idle mode, or 2) only while the UE performs a TAU (Tracking Area Update) procedure for not generating a user plane.

As a result, while the UE is in connected mode, the MME does not perform the relocation to the P-GW despite that another P-GW is more appropriate for the current location of the UE.

Furthermore, in an existing radio communication system (i.e., a legacy system before CSIPTO application), although multiple P-GWs can service the same APN, if a single user equipment configures multiple PDNs for the same PDN, it is restricted to be serviced through the same P-GW.

Accordingly, in 3GPP Release 13, even if a UE is in connected mode, a scheme of providing relation to a P-GW more appropriate for a current location of the UE by minimizing service disruption is currently studied.

The following is the objective of CSIPTO (Co-ordinated P-GW change for SIPTO) currently studied by 3GPP SA.

The objective is to study use cases and identify potential requirements for network consideration of
a) end-user experience and preferences and
b) UE's knowledge of ongoing IP flow types
; regarding the change of the local P-GW in use for SIPTO.

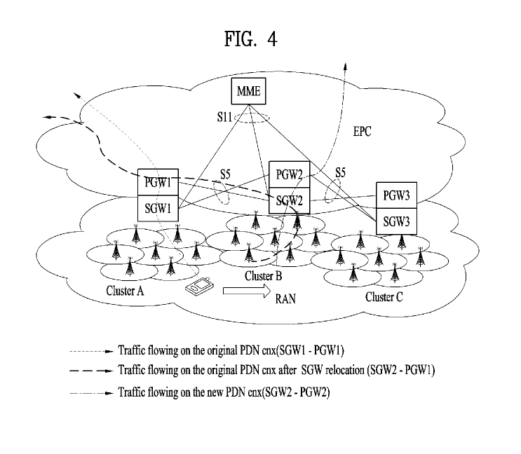

Regarding this, referring to the currently studied 3GPP TR 22.828v1.0.0, a scenario such as FIG. 4 7 can be taken into consideration.

When a UE requests a PDN connection to a specific Access Point Name (APN), an MME selects PGW1 that is geographically close to a current location of the UE, in order to optimize the backhaul transport (S1 and S5 tunnels) via an Evolved Packet Core (EPC) network.

A user of the UE starts a long-lived flow service for which service continuity is essential and IP address preservation is required (e.g., a conference call via a conference bridge). The UE's user has just moved from Cluster A to Cluster B.

In doing so, the MME had moved the user/UE's connection to SGW2 but the connection is still tunnelled through PGW1 which is not the closest PGW to the user/UE's current locations.

Namely, since service continuity is essential and IP address preservation is required, the UE maintains its PDN connection to PGW1 while requesting a new PDN connection for the same service type. The new PDN connection is then established to PGW2.

Once the connection to PGW2 is established, all new IP flows are directed to PGW2, except for any long-lived service flows. At the same time, the existing long-lived service flows are still directed to the PGW1, thus ensuring service continuity of the long-lived service flows.

The PDN connection to PGW1 is released only: i) when all the long-lived flows flowing on it have expired; or ii) when it becomes impractical to keep the PDN connection to PGW1, whichever event occurs first.

In the following description, for a UE having moved into Cluster B from Cluster A, as shown in FIG. 4, an existing PDN connection through SGW2 and PGW1 is called a suboptimal PDN connection and a newly established PDN connection through SGW2 and PGW2 is called an optimal PDN connection. Definitions of ‘optimal’ and ‘suboptimal’ can be based on various implementation criteria such as geography, topology and load balancing.

According to the present invention, a suboptimal PDN connection can be named an old (previous) PDN connection, an existing PDN connection, a first PDN connection, or an original PDN connection, which can be construed as having the same meaning. An optimal PDN connection can be named a new PDN connection, a newly established PDN connection, or a second PDN connection, which can be construed as having the same meaning.

Further, according to the present invention, traffic, service, IP service, flow, IP flow, service flow, packet, IP packet, data, and application are interchangeably used. A long-lived flow service is interchangeably used with a service flow requiring IP address preservation or a service flow requiring service continuity, and a short-lived flow service is interchangeably used with a service flow not requiring IP address preservation or a service flow not requiring service continuity. For reference, examples of the short-lived flow service may include texting, web browsing, and the like. And, examples of the long-lived flow service may include a long-term conference call, a video call, a large file transfer, and the like.

### Legacy APN-AMBR Operating Method

APN-AMBR (per APN Aggregate Maximum Bit Rate) is defined in 3GPP TS 23.401. APN-AMBR exists as a subscription parameter stored per APN of HSS. Yet, APN-AMBR to be substantially applied can be reconfigured by PCRF (policy and charging rules function) or MME. This limits the aggregate bit rate that can be provided across all NON-GBR (non-guaranteed bit rate) bearers and across all PDN connections of the same APN (e.g. excess traffic may get discarded by a rate shaping function).

Moreover, each of the NON-GBR bearers could potentially use the entire APN-AMBR (e.g. when other NON-GBR bearers do not carry any traffic). GBR bearers are outside the scope of APN-AMBR. The P-GW enforces the APN-AMBR in downlink. Enforcement of APN-AMBR in uplink may be done in the UE and additionally in the P-GW. In this case, as mentioned in the foregoing description, all simultaneous active PDN connections of the UE are associated with the same APN provided by the same PDN GW.

APN-AMBR may apply to all PDN connections of an APN. For the case of multiple PDN connections of an APN, i) if a change of APN-AMBR occurs due to local policy or ii) the updated APN-AMBR for each PDN connection is provided from the MME or PCRF, the PGW initiates explicit signalling for updating the changed APN-AMBR.

In particular, packet discarding by a rate shaping function and the like is performed in a manner of applying APN-AMBR in uplink direction and APN-AMBR in downlink direction to a UE stage and a P-GW stage, respectively. In case that multiple PDN connections are established at the same APN, a single APN-AMBR value is applied as well. Namely, all Non-GBR bearers connected to a single APN are controlled by a single integrated APN-AMBR.

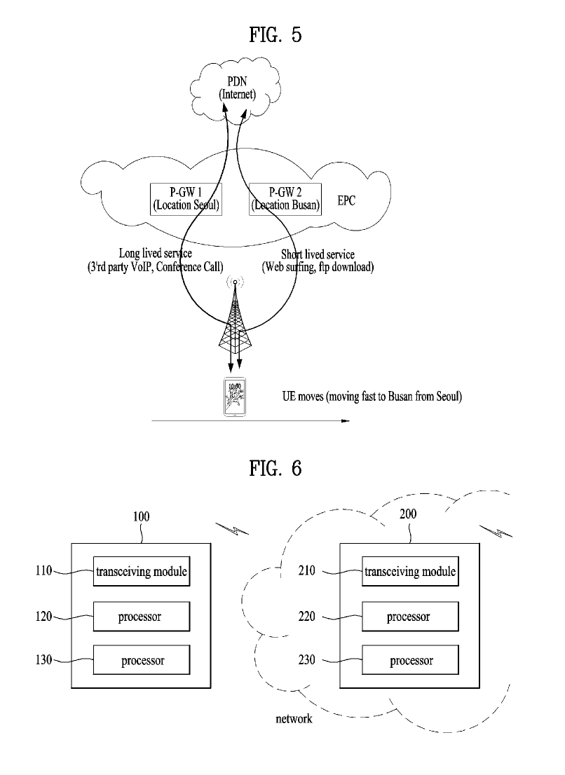

Yet, if the legacy APN-AMBR operating method is applied to CSIPTO as it is, it may cause a problem in case of APN-AMBR handling. FIG. 5 is a reference diagram to describe a case of APN-AMBR handling on CSIPTO.

Referring to FIG. 5, when a user equipment moves, if CSIPTO is applied, a long-lived service (i.e., 3^{rd} party VoIP in case that IP preservation is necessary for example) is maintained through a sub-optimal connection and a shot-lived service (e.g., Web surfing) can be maintained through an optimal connection. In this case, if the long-lived service is a service provided by a third party, since the service is connected through an internet PDN, the long-lived service and the short-lived service may be provided by the same PDN (internet APN). In particular, according to CSIPTO, as a sub-optimal connection and an optimal connection are established for different P-GWs, a scheme of handling APN-AMBR is required.

Therefore, in the present invention, a scheme of applying a legacy APN-AMBR handling method to CSIPTO is described. First of all, in TR 22.828 v 1.00, an APN-AMBR establishing method for CSIPTO is proposed as Table 2.

In Table 2, in case that each PDN connection to a different P-GW is established for the same APN, it is assumed that APN-AMBR can be established through temporary relaxation. In particular, in case of multiple PDN connections on a legacy wireless communication system, unlike that a rate shaping is performed with a single APN-AMBR in case of connection to the same APN, CSIPTO can be applied to control APN-AMBR per PDN connection. The reason for this is described as follows. First of all, compared to the case that all PDN connections established for the same PAN are connected to one P-GW in case of the existing multiple PDN connections, optimal PDN connection and suboptimal PDN connection, which are the two PDN connections toward one APN, are established as an old P-GW maintaining an existing service and a new P-GW corresponding to an optimal location. Hence, multiple PDNS toward the same APN should be connected to different P-GWs and controlled. Accordingly, in the paragraph 4.1.5 of 3GPP TR.828, it is defined that APN-AMBR is assigned to each PDN connection.

Yet, since a service of a long-lived type is assumed for the case of a suboptimal PDN connection, how long the two PDN connections are simultaneously maintained is not known.

Hence, in order to maintain the impartiality with the existing UEs, a charging mechanism may vary in some cases. For the same impartiality, in case of applying CSIPTO, 50% of APN-AMBR usable for each P-GW may be assigned in comparison with the existing UE. In case of setting an APN-AMBR reference of the CSIPTO applied UE to a value smaller than that of the existing UE, such a static establishing method causes a situation that a maximum data rate is lowered than the case of servicing the multiple PDNs with the existing same P-GW. Therefore, in case of a UE having a PDN connection relocated to CSIPTO, a corresponding service experience of the UE may be degraded. For instance, despite that all Non-GBR services of the UE are serviced through the optimal PDN connection, if APN-AMBR for an optimal PDN (i.e., the corresponding P-GW) is assigned as 50%, the UE can use only 50% of the aggregate bit rate in comparison with other user equipments, the service experience of the corresponding UE is degraded.

Therefore, the present invention proposes a more efficient APN-AMBR operation based on the above description. In particular, the present invention proposes an APN-AMBR operating method for efficiently providing CSIPTO (Co-ordinated Selected IP Traffic Offload) in such a mobile communication system as a 3GPP EPS (Evolved Packet System).

### 1. APN-AMBR to be Used by UE

It is assumed that a UE can be aware that a PDN connection to the same APN is established to another P-GW. This is enabled in a manner that a recognizer specifying it is included in case of performing an optimal PDN connection establishment.

The UE calculates APN-AMBR, which is to be used for a PDN connection handled into another P-GW despite belonging to the same APN, using methods 1-A to 1C for APN-AMBR calculation proposed in the following, applies the corresponding value for an uplink direction from the UE, and informs a NW node of the corresponding value so as to support the NW node to determine APN-AMBR to be applied in a downlink/uplink direction by a P-GW.

### Method 1-A:

A UE establishes an APN-AMBR value appropriate for each PDN connection by confirming the corresponding Non-GBR number per PDN connection to the same APN and may use it for a rate shaping function in an uplink direction.

For example, when a single PDN connection exists, if a single Non-GBR bearer exists in the corresponding PDN connection, all APN-AMBRs are used for the corresponding bearer handling. If an additional PDN connection to the same APN is established through another P-GW, the UE can assign an APN-AMBR value to meet the Non-GBR number by confirming the Non-GBR bearer number assigned to the additional PDN connection. In particular, if the UE recognizes that N Non-GBR bearers and M Non-GBR bearers are assigned to a PDN connection to P-GW1 and a PDN connection to P-GW2, respectively, APN-AMBR*(N/N+M) and APN-AMBR*(M/N+M) are assigned to the PDN connection to P-GW1 and the PDN connection to P-GW2, respectively.

### Method 1-B:

As an alternative of the Method 1-A, a default bearer of a suboptimal may not be included in the Non-GBR number. In particular, if N Non-GBR bearers and M Non-GBR bearers exist in an optimal PDN connection and a suboptimal PDN connection, respectively, APN-AMBR can be calculated by the following.
APN-AMBR of Optimal PDN connection: APN-AMBR*(N/(N+M−1))
APN-AMBR of suboptimal PDN connection: APN-AMBR*((M−1)/(N+M−1))

The reason for this is described as follows. First of all, in case of a suboptimal PDN connection for transmitting an IP traffic of the long-lived, a single default bearer and a multitude of dedicated bearers can be configured. In this case, it is highly possible that the corresponding dedicated bearer is a GBR bearer (yet, a case that some of Non-GBR requires a specific QoS is possible). Namely, like the standardized QCI shown in Table B, an IP preservation required service may include Conversational voice/Conversational video/real time gaming, or the like.

TABLE B

| | | | | Packet | |
|---|---|---|---|---|---|
| | | | | Error | |
| | | | Packet | Loss | |
| | Resource | Priority | Delay | Rate | |
| QCI | Type | Level | Budget | (NOTE 2) | Example Services |
| 1 | GBR | 2 | 100 ms | 10⁻² | Conversational Voice |
| (NOTE 3) | | | (NOTE 1, | | |
| | | | NOTE 11) | | |
| 2 | | 4 | 150 ms | 10⁻³ | Conversational Video (Live |
| (NOTE 3) | | | (NOTE 1, | | Streaming) |
| | | | NOTE 11) | | |
| 3 | | 3 | 50 ms | 10⁻³ | Real Time Gaming |
| (NOTE 3) | | | (NOTE 1, | | |
| | | | NOTE 11) | | |
| 4 | | 5 | 300 ms | 10⁻⁶ | Non-Conversational Video (Buffered |
| (NOTE 3) | | | (NOTE 1, | | Streaming) |
| | | | NOTE 11) | | |
| 65 | | 0.7 | 75 ms | 10⁻² | Mission Critical user plane Push To |
| (NOTE 3, | | | (NOTE 7, | | Talk voice (e.g., MCPTT) |
| NOTE 9) | | | NOTE 8) | | |
| 66 | | 2 | 100 ms | 10⁻² | Non-Mission-Critical user plane Push |
| (NOTE 3) | | | (NOTE 1, | | To Talk voice |
| | | | NOTE 10) | | |
| 5 | Non- | 1 | 100 ms | 10⁻⁶ | IMS Signalling |
| (NOTE 3) | GBR | | (NOTE 1, | | |
| | | | NOTE 10) | | |
| 6 | | 6 | 300 ms | 10⁻⁶ | Video (Buffered Streaming) |
| (NOTE 4) | | | (NOTE 1, | | TCP-based (e.g., www, e-mail, chat, |
| | | | NOTE 10) | | ftp, p2p file sharing, progressive video, |
| | | | | | etc.) |
| 7 | | 7 | 100 ms | 10⁻³ | Voice, |
| (NOTE 3) | | | (NOTE 1, | | Video (Live Streaming) |
| | | | NOTE 10) | | Interactive Gaming |
| 8 | | 8 | 300 ms | 10⁻⁶ | Video (Buffered Streaming) |
| (NOTE 5) | | | (NOTE 1) | | TCP-based (e.g., www, e-mail, chat, |
| 9 | | 9 | | | ftp, p2p file |
| (NOTE 6) | | | | | sharing, progressive video, etc.) |
| 69 | | 0.5 | 60 ms | 10⁻⁶ | Mission Critical delay sensitive |
| (NOTE 3, | | | (NOTE 7, | | signalling (e.g., MC-PTT signalling) |
| NOTE 9) | | | NOTE 8) | | |
| 70 | | 5.5 | 200 ms | 10⁻⁶ | Mission Critical Data (e.g. example |
| (NOTE 4) | | | (NOTE 7, | | services are the same as QCI 6/8/9) |
| | | | NOTE 10) | | |

In particular, it is barely possible that IP traffic of QCI 8 level is transmitted through a suboptimal PDN connection. Hence, if a non-GBR bearer is not configured as a dedicated bearer through a suboptimal PDN connection, it is further effective that a fast data service is enabled by assigning more APN-AMBR to an optimal PDN connection.

### Method 1-C:

A UE delivers ‘UE requested APM-AMBR’ calculated by the Method 1-A or the Method 1-B to a network entity (e.g., MME). Based on this, a network may reconfigure APN-AMBR, which is appropriate per PDN connection established for each P-GW, for the UE.

### APN-AMBR to Be Used by P-GW

If a UE delivers ‘UE requested APN-AMBR’ to a network entity (i.e., MME) for uplink/downlink direction APN-AMBR calculation, a P-GW may use the corresponding value or re-calculate APN-AMBR on the basis of the corresponding value. In performing the re-calculation, each P-GW load information and configured bearer properties are usable, which may be performed by the MME or through a PCC (policy and charging control) procedure.

Moreover, available are: i) a method for an MME to calculate APN-AMBR through PDN connection information (a presence or non-presence of belonging to a same APN, information indicating whether to be connected to another P-GW, per-PDN connection bearer QoS information, etc.) without ‘UE requested APM-AMBR value’ delivery by the UE; and ii) a method for a P-GW to calculate APN-AMBR in a manner that an MME gives the P-GW a presence or non-presence of a PDN connection to another P-GW belonging to a same APN, a bearer QoS of the corresponding PDN connection and the like, etc.

### Method 2-A:

A UE can inform a network entity of ‘UE requested APN-AMBR’ value established in a UL direction by the UE. In particular, since the UE is well aware of a handling of a Non-GBR, information on it can be notified to each P-GW having an optimal or suboptimal PDN connection established thereto so as to be used without processing. Namely, when the optimal PDN connection establishment is performed, ‘UE requested APN-AMBR’ is notified. And, for an already-established suboptimal PDN connection, modification into ‘UE requested APN-AMBR’ to be used for a corresponding P-GW is possible through a procedure such as ‘UE requested Bearer resource modification’ and the like. Moreover, a new message may be defined and used.

Moreover, if the UE delivers ‘UE requested APN-AMBR’ to an MME or P-GW, a network entity recalculates an appropriate APN-AMBR based on it and is then able to use the recalculated one as an APN-AMBR for downlink. Or, the network entity calculates an APN-AMBR for uplink available for the UE and is able to deliver it to the UE.

### Method 2-B:

A UE does not deliver ‘UE requested APN-AMBR’, but an MME can calculate APN-AMBR through PDN connection information (e.g., a presence or non-presence of belonging to a same APN, information connected to another P-GW, per-PDN connection bearer QoS information, etc.). And, a method for calculating APN-AMBR through a PCC procedure of P-GW in a manner that an MME gives the P-GW a presence or non-presence of a PDN connection to another P-GW belonging to a same APN, a bearer QoS of the corresponding PDN connection and the like is also available.

In particular, if an MME makes a request for a new optimal PDN connection to a UE, the MME obtains bearer information on the corresponding PDN connection. In doing so, if an existing PDN connection is not released, the MME configures an APN-AMBR value in consideration of a balance for two PDN connections and then informs a P-GW of the configured value as well. In some cases, the configured value may be delivered to the UE so as to be used by the UE.

FIG. 6 is a diagram for configuration of one example of a user equipment device and a network node device according to a preferred embodiment of the present invention.

Referring to FIG. 6, a user equipment device 100 according to the present invention may include a transceiving module 110, a processor 120 and a memory 130. The transceiving module 110 may be configured to transmit various signals, data and informations to an external device and receive various signals, data and informations from the external device. The user equipment device 100 may be connected to the external device by wire and/or wireless. The processor 120 may control overall operations of the user equipment device 100 and be configured to perform a function of operating information and the like to be transceived with the external device by the user equipment device 100. The memory 130 may store the operated information and the like for prescribed duration and may be substituted with such a component as a buffer (not shown in the drawing) and the like.

Referring to FIG. 6, a network node device 200 according to the present invention may include a transceiving module 210, a processor 220 and a memory 230. The transceiving module 210 may be configured to transmit various signals, data and informations to an external device and to receive various signals, data and informations from the external device. The network node device 200 may be connected to the external device by wire and/or wireless. The processor 220 may control overall operations of the network node device 200 and may be configured to perform a function of operating information and the like to be transceived with the external device by the network node device 200. The memory 230 may store the operated information and the like for prescribed duration and may be substituted with such a component as a buffer (not shown in the drawing) and the like.

The detailed configurations of the user equipment device 100 and the network node device 200 mentioned in the above description may be implemented in a manner that the matters of the various embodiments of the present invention mentioned in the foregoing description are independently applicable or that at least two of the various embodiments of the present invention are simultaneously applicable. And, duplicate contents may be omitted for clarity.

Embodiments of the present invention may be implemented using various means. For instance, embodiments of the present invention may be implemented using hardware, firmware, software and/or any combinations thereof

In case of the implementation by hardware, a method according to each embodiment of the present invention may be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention may be implemented by modules, procedures, and/or functions for performing the above-explained functions or operations. Software code is stored in a memory unit and is then drivable by a processor. The memory unit is provided within or outside the processor to exchange data with the processor through the various means known to the public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations may be made therein without departing from the spirit and scope of the invention. For example, those skilled in the art may use the respective configurations disclosed in the aforementioned embodiments in a manner of combining such configurations with each other. Therefore, the present invention is non-limited by the embodiments disclosed herein but intends to give a broadest scope matching the principles and new features disclosed herein.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. And, it is apparently understandable that an embodiment is configured by combining claims failing to have relation of explicit citation in the appended claims together or can be included as new claims by amendment after filing an application.

### INDUSTRIAL APPLICABILITY

The embodiments of the present invention mentioned in the foregoing description are applicable to various kinds of mobile communication systems.

What is claimed is:

1. A method for configuring an APN-AMBR (per APN aggregate maximum bit rate) of a user equipment in a wireless communication system supportive of CSIPTO (coordinated selected IP traffic offload), comprising:
establishing multiple PDN connections associated with different P-GW (packet data network gateways) for a same APN (access point name);
calculating APN-AMBRs for the multiple PDN connections based on the number of non-GBR (non-guaranteed bit rate) bearers for the respective multiple PDN connections, respectively; and
applying the APN-AMBRs to the corresponding PDN connections, respectively.

2. The method of claim 1, wherein the multiple PDN connections comprise a first PDN connection associated with a first P-GW according to movement of the user equipment and a second PDN connection associated with a second P-GW according to a location before the movement of the user equipment.

3. The method of claim 2, wherein the calculating the APN-AMBRs is performed in case of receiving an indicator indicating the first P-GW different from the second P-GW according to the first PDN connection configuration.

4. The method of claim 2, wherein the number of the non-GBR bearers of the second PDN connection comprises the number of the non-GBR bearers except a default bearer.

5. The method of claim 2, wherein the second PDN connection is maintained until a service continuity & IP preservation requested long-lived service flow expires.

6. The method of claim 1, further comprising transmitting the APN-AMBRs for the respective multiple PDN connections to a network entity.

7. The method of claim 6, comprising receiving a downlink signal according to the APN-AMBR of the network entity reconfigured based on the APN-AMBRs for the respective multiple PDN connections from the network entity.

8. The method of claim 1, comprising receiving a downlink signal according to the APN-AMBRs for the respective multiple PDN connections calculated based on PDN connection information.

9. The method of claim 8, wherein the PDN connection information comprises at least one selected from the group consisting of an information indicating whether the multiple PDN connections belong to the same APN, information indicating whether the multiple PDN connections are connected to a different P-GW, and bearer QoS (quality of service) information for each of the multiple PDN connections.

10. A user equipment for configuring an APN-AMBR (per APN aggregate maximum bit rate) in a wireless communication system supportive of CSIPTO (coordinated selected IP traffic offload), comprising:
a radio frequency unit; and
a processor configured to establish multiple PDN connections associated with different P-GW (packet data network gateways) for a same APN (access point name), calculate APN-AMBRs for the multiple PDN connections based on the number of non-GBR (non-guaranteed bit rate) bearers for the respective multiple PDN connections, respectively, and apply the APN-AMBRs to the corresponding PDN connections, respectively.
